(19) United States
(12) Patent Application Publication
(10) Pub. No.: US 2010/0162165 A1
(43) Pub. Date: Jun. 24, 2010

(54) User Interface Tools

(75) Inventors: Viswanadh Addala, Campbell, CA (US); Edward L. Ford, Santa Clara, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/341,716

(22) Filed: Dec. 22, 2008

(51) Int. Cl. G06F 3/048

(52) U.S. Cl. 715/810

(57) ABSTRACT

Methods, systems, and apparatus, including computer program products, for generating user interface tools are disclosed. In one aspect, a method includes identifying a resource (e.g., a web page) for display in an interface, identifying one or more user interface elements in the resource, generating a tool based on the one or more user interface elements, and combining the tool and the resource for display in the interface.

### TECHNICAL FIELD

This subject matter is generally related to user interface tools for electronic devices.

### BACKGROUND

Resources, such as but not limited to web pages, text documents, and databases may be too large to be practically displayed in their entirety in a display of an electronic device. For example, a database may include too many records to display at once on a screen of a computer monitor, such that a size of text in the records is readable by a user. As another example, a search engine web page displayed in a web browser may include multiple search options that fill the screen, and a “submit” button to proceed with a search may not be displayed on the screen. It may be difficult or inconvenient for a user to navigate to other portions of a resource (e.g., the database or search engine web page), for example, so that other information or objects (e.g., input fields, controls, tools) are displayed on the display. Furthermore, as a size of the display or screen resolution (e.g., screen real estate) of the electronic device decreases, the difficulty or inconvenience of navigating to the other portions of a resource may increase.

### SUMMARY

In general, one aspect of the subject matter described in this specification can be embodied in methods that include the actions of identifying a resource (e.g., a web page) for display in an interface, identifying one or more user interface elements in the resource, generating a tool based on the one or more user interface elements, and combining the tool and the resource for display in the interface. Other embodiments of this aspect include corresponding systems, apparatus, and computer program products.

Particular embodiments of the subject matter described in this specification can be implemented to realize one or more of the following advantages. Superimposing a toolbar on an interface can improve an ease of navigating in a user interface by: (i) reducing an amount of screen real estate used, and (ii) improve an ease of locating tools (e.g., that may not exist in the resource, or may not be currently displayed); thereby improving a user's experience. Because tools can be presented in a known location, the time user's spend searching for the tools can be decreased. In addition, the dynamic nature of the toolbar (e.g., ability to adaptively present tools based on context, such as the user's input) also improves the user's experience.

### DESCRIPTION OF DRAWINGS

FIG. 1 illustrates an example mobile device.

FIG. 2 is a block diagram of an example network operating environment for the mobile device of FIG. 1.

FIG. 3 is a block diagram of an example architecture for the mobile device of FIG. 1.

FIG. 4 illustrates an example interface that includes a toolbar.

FIG. 5A illustrates an example interface that includes a toolbar presented at a location based on a first user input.

FIG. 5B illustrates an example interface that includes a toolbar presented at a location based on a second user input.

FIG. 6 illustrates an example interface that includes a heads up display.

FIG. 7 is a flow diagram of an example process for superimposing a toolbar on an interface.

FIG. 8A illustrates an example interface that includes a toolbar.

FIG. 8B illustrates the example interface of FIG. 8A that further includes a heads up display.

### DETAILED DESCRIPTION

### Example Mobile Device

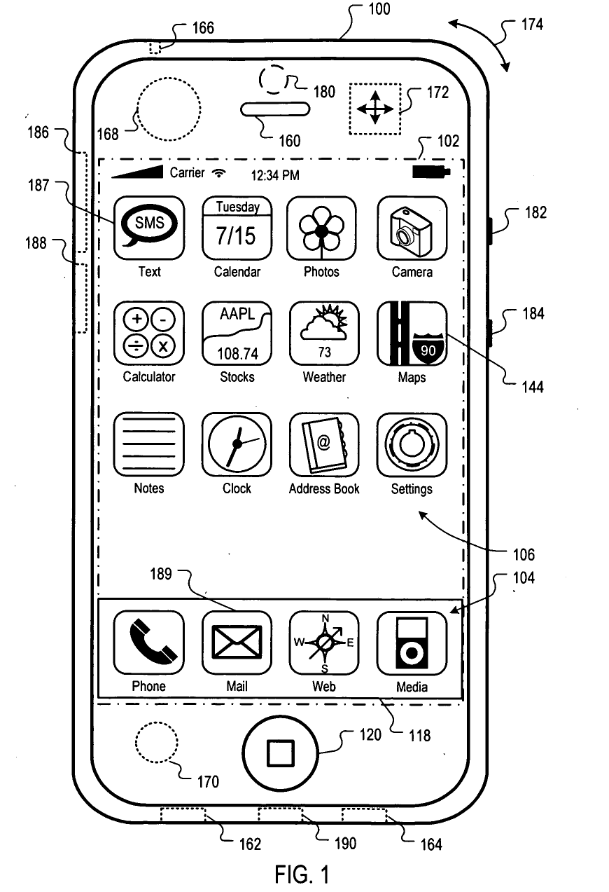

FIG. 1 is a block diagram of an example mobile device 100. The mobile device 100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

### Mobile Device Overview

In some implementations, the mobile device 100 includes a touch-sensitive display 102. The touch-sensitive display 102 can implement liquid crystal display (LCD) technology, light emitting polymer display (LPD) technology, or some other display technology. The touch-sensitive display 102 can be sensitive to haptic and/or tactile contact with a user.

In some implementations, the touch-sensitive display 102 can comprise a multi-touch-sensitive display 102. A multi-touch-sensitive display 102 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 100 can display one or more graphical user interfaces on the touch-sensitive display 102 for providing the user access to various system objects and for conveying information to the user. In some implementations, the graphical user interface can include one or more display objects 104 and 106. In the example shown, the display objects 104 and 106, are graphic representations of system objects. Some examples of system objects include device functions, applications, windows, files, alerts, events, or other identifiable system objects.

### Example Mobile Device Functionality

In some implementations, the mobile device 100 can implement multiple device functionalities, such as a telephony device, an e-mail device, a network data communication device, a Wi-Fi base station device (not shown), and a media processing device. In some implementations, particular display objects 104 can be displayed in a menu bar 118. In some implementations, device functionalities can be accessed from a top-level graphical user interface, such as the graphical user interface illustrated in FIG. 1. Touching one of the display objects 104 can, for example, invoke corresponding functionality. For example, touching the display object 189 would invoke an email application on the mobile device 100, for example.

In some implementations, the mobile device 100 can implement network distribution functionality. For example, the functionality can enable the user to take the mobile device 100 and provide access to its associated network while traveling. In particular, the mobile device 100 can extend Internet access (e.g., Wi-Fi) to other wireless devices in the vicinity. For example, mobile device 100 can be configured as a base station for one or more devices. As such, mobile device 100 can grant or deny network access to other wireless devices.

In some implementations, upon invocation of device functionality, the graphical user interface of the mobile device 100 changes, or is augmented or replaced with another user interface or user interface elements, to facilitate user access to particular functions associate d with the corresponding device functionality. For example, in response to a user touching a phone object, the graphical user interface of the touch-sensitive display 102 may present display objects related to various phone functions; likewise, touching of an email object may cause the graphical user interface to present display objects related to various e-mail functions; touching a Web object may cause the graphical user interface to present display objects related to various Web-surfing functions; and touching a media player object may cause the graphical user interface to present display objects related to various media processing functions.

In some implementations, the top-level graphical user interface environment or state of FIG. 1 can be restored by pressing a button 120 located near the bottom of the mobile device 100. In some implementations, each corresponding device functionality may have corresponding “home” display objects displayed on the touch-sensitive display 102, and the top-level graphical user interface environment of FIG. 1 can be restored by pressing the “home” display object.

In some implementations, the top-level graphical user interface can include additional display objects 106, such as a short messaging service (SMS) object 187, a calendar object, a photos object, a camera object, a calculator object, a stocks object, a weather object, a maps object 144, a notes object, a clock object, an address book object, and a settings object. Touching the maps object 144 can, for example, invoke a mapping and location-based services environment and supporting functionality; likewise, a selection of any of the display objects 106 can invoke a corresponding object environment and functionality.

Additional and/or different display objects can also be displayed in the graphical user interface of FIG. 1. For example, if the device 100 is functioning as a base station for other devices, one or more “connection” objects may appear in the graphical user interface to indicate the connection. In some implementations, the display objects 106 can be configured by a user, e.g., a user may specify which display objects 106 are displayed, and/or may download additional applications or other software that provides other functionalities and corresponding display objects.

In some implementations, the mobile device 100 can include one or more input/output (I/O) devices and/or sensor devices. For example, a speaker 160 and a microphone 162 can be included to facilitate voice-enabled functionalities, such as phone and voice mail functions. In some implementations, an up/down button 184 for volume control of the speaker 160 and the microphone 162 can be included. The mobile device 100 can also include an on/off button 182 for a ring indicator of incoming phone calls. In some implementations, a loud speaker 164 can be included to facilitate hands-free voice functionalities, such as speaker phone functions. An audio jack 166 can also be included for use of headphones and/or a microphone.

In some implementations, a proximity sensor 168 can be included to facilitate the detection of the user positioning the mobile device 100 proximate to the user's ear and, in response, to disengage the touch-sensitive display 102 to prevent accidental function invocations. In some implementations, the touch-sensitive display 102 can be turned off to conserve additional power when the mobile device 100 is proximate to the user's ear.

Other sensors can also be used. For example, in some implementations, an ambient light sensor 170 can be utilized to facilitate adjusting the brightness of the touch-sensitive display 102. In some implementations, an accelerometer 172 can be utilized to detect movement of the mobile device 100, as indicated by the directional arrow 174. Accordingly, display objects and/or media can be presented according to a detected orientation, e.g., portrait or landscape. In some implementations, the mobile device 100 may include circuitry and sensors for supporting a location determining capability, such as that provided by the Global Positioning System (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 100 or provided as a separate device that can be coupled to the mobile device 100 through an interface (e.g., port device 190) to provide access to location-based services.

In some implementations, a port device 190, e.g., a Universal Serial Bus (USB) port, or a docking port, or some other wired port connection, can be included. The port device 190 can, for example, be utilized to establish a wired connection to other computing devices, such as other communication devices 100, network access devices, a personal computer, a printer, a display screen, or other processing devices capable of receiving and/or transmitting data. In some implementations, the port device 190 allows the mobile device 100 to synchronize with a host device using one or more protocols, such as, for example, the TCP/IP, HTTP, UDP and any other known protocol.

The mobile device 100 can also include a camera lens and sensor 180. In some implementations, the camera lens and sensor 180 can be located on the back surface of the mobile device 100. The camera can capture still images and/or video.

The mobile device 100 can also include one or more wireless communication subsystems, such as an 802.11b/g communication device 186, and/or a Bluetooth™ communication device 188. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

### Network Operating Environment

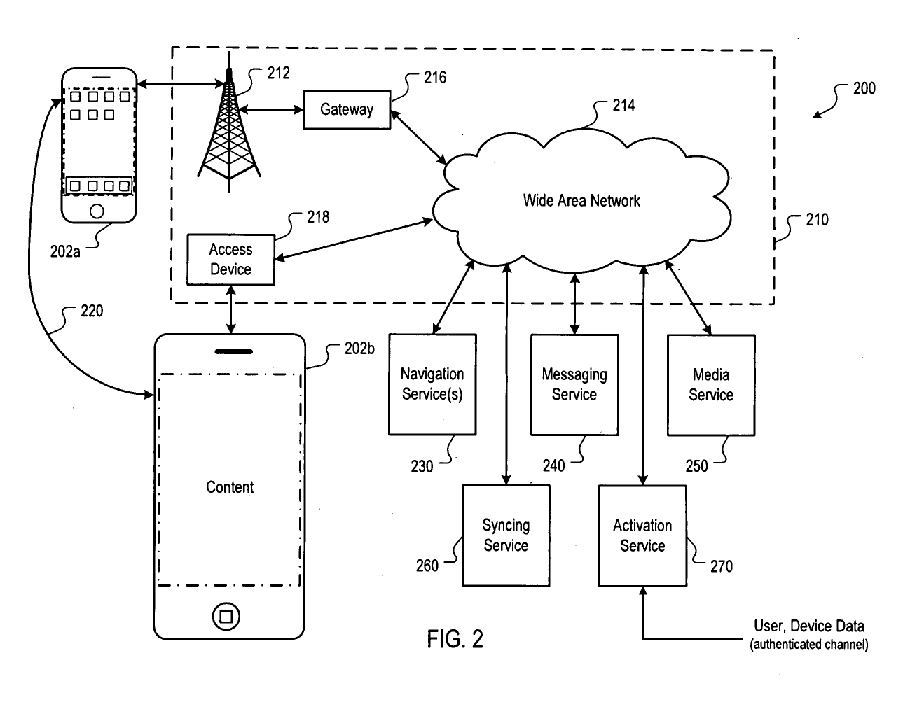

FIG. 2 is a block diagram of an example network operating environment for the mobile device of FIG. 1. Mobile devices 202a and 202b can, for example, communicate over one or more wired and/or wireless networks 210 in data communication. For example, a wireless network 212, e.g., a cellular network, can communicate with a wide area network (WAN) 214, such as the Internet, by use of a gateway 216. Likewise, an access device 218, such as an 802.11g wireless access device, can provide communication access to the wide area network 214. In some implementations, both voice and data communications can be established over the wireless network 212 and the access device 218. For example, the mobile device 202a can place and receive phone calls (e.g., using VoIP protocols), send and receive e-mail messages (e.g., using POP3 protocol), and retrieve electronic documents and/or streams, such as web pages, photographs, and videos, over the wireless network 212, gateway 216, and wide area network 214 (e.g., using TCP/IP or UDP protocols). Likewise, in some implementations, the mobile device 202b can place and receive phone calls, send and receive e-mail messages, and retrieve electronic documents over the access device 218 and the wide area network 214. In some implementations, the mobile device 202a or 202b can be physically connected to the access device 218 using one or more cables and the access device 218 can be a personal computer. In this configuration, the mobile device 202a or 202b can be referred to as a “tethered” device.

The mobile devices 202a and 202b can also establish communications by other means. For example, the wireless device 202a can communicate with other wireless devices, e.g., other mobile devices 202a or 202b, cell phones, etc., over the wireless network 212. Likewise, the mobile devices 202a and 202b can establish peer-to-peer communications 220, e.g., a personal area network, by use of one or more communication subsystems, such as the Bluetooth™ communication devices 188 shown in FIG. 1. Other communication protocols and topologies can also be implemented.

The mobile device 202a or 202b can, for example, communicate with one or more services 230, 240, 250, 260, and 270 over the one or more wired and/or wireless networks 210. For example, one or more navigation services 230 can provide navigation information, e.g., map information, location information, route information, and other information, to the mobile device 202a or 202b. A user of the mobile device 202b can invoke a map functionality, e.g., by pressing the maps object 144 on the top-level graphical user interface shown in FIG. 1, and can request and receive a map for a particular location, request and receive route directions, or request and receive listings of businesses in the vicinity of a particular location, for example.

A messaging service 240 can, for example, provide e-mail and/or other messaging services. A media service 250 can, for example, provide access to media files, such as song files, audio books, movie files, video clips, and other media data. In some implementations, separate audio and video services (not shown) can provide access to the respective types of media files. A syncing service 260 can, for example, perform syncing services (e.g., sync files). An activation service 270 can, for example, perform an activation process for activating the mobile device 202a or 202b. Other services can also be provided, including a software update service that automatically determines whether software updates exist for software on the mobile device 202a or 202b, then downloads the software updates to the mobile device 202a or 202b where the software updates can be manually or automatically unpacked and/or installed.

The mobile device 202a or 202b can also access other data and content over the one or more wired and/or wireless networks 210. For example, content publishers, such as news sites, RSS feeds, web sites, blogs, social networking sites, developer networks, etc., can be accessed by the mobile device 202a or 202b. Such access can be provided by invocation of a web browsing function or application (e.g., a browser) in response to a user touching, for example, a Web object.

### Example Mobile Device Architecture

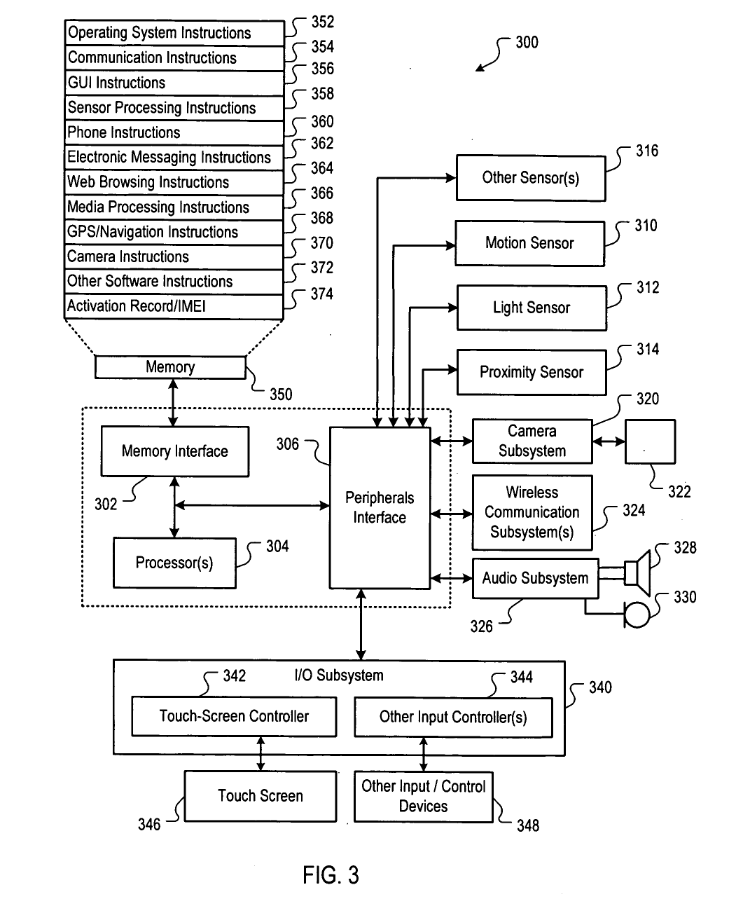

FIG. 3 is a block diagram of an example architecture for the mobile device of FIG. 1. The mobile device 100 can include a memory interface 302, one or more data processors, image processors and/or central processing units 304, and a peripherals interface 306. The memory interface 302, the one or more processors 304 and/or the peripherals interface 306 can be separate components or can be integrated in one or more integrated circuits. The various components in the mobile device 100 can be coupled by one or more communication buses or signal lines.

Sensors, devices, and subsystems can be coupled to the peripherals interface 306 to facilitate multiple functionalities. For example, a motion sensor 310, a light sensor 312, and a proximity sensor 314 can be coupled to the peripherals interface 306 to facilitate the orientation, lighting, and proximity functions described with respect to FIG. 1. Other sensors 316 can also be connected to the peripherals interface 306, such as a positioning system (e.g., GPS receiver), a temperature sensor, a biometric sensor, or other sensing device, to facilitate related functionalities.

A camera subsystem 320 and an optical sensor 322, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 324, which can include radio frequency receivers and transmitters and/or optical (e.g., infrared) receivers and transmitters. The specific design and implementation of the communication subsystem 324 can depend on the communication network(s) over which the mobile device 100 is intended to operate. For example, a mobile device 100 may include communication subsystems 324 designed to operate over a GSM network, a GPRS network, an EDGE network, a Wi-Fi or WiMax network, and a Bluetooth™ network. In particular, the wireless communication subsystems 324 may include hosting protocols such that the device 100 may be configured as a base station for other wireless devices.

An audio subsystem 326 can be coupled to a speaker 328 and a microphone 330 to facilitate voice-enabled functions, such as voice recognition, voice replication, digital recording, and telephony functions.

The I/O subsystem 340 can include a touch screen controller 342 and/or other input controller(s) 344. The touch-screen controller 342 can be coupled to a touch screen 346. The touch screen 346 and touch screen controller 342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 346.

The other input controller(s) 344 can be coupled to other input/control devices 348, such as one or more buttons, rocker switches, thumb-wheel, infrared port, USB port, and/or a pointer device such as a stylus. The one or more buttons (not shown) can include an up/down button for volume control of the speaker 328 and/or the microphone 330.

In one implementation, a pressing of the button for a first duration may disengage a lock of the touch screen 346; and a pressing of the button for a second duration that is longer than the first duration may turn power to the mobile device 100 on or off. The user may be able to customize a functionality of one or more of the buttons. The touch screen 346 can, for example, also be used to implement virtual or soft buttons and/or a keyboard.

In some implementations, the mobile device 100 can present recorded audio and/or video files, such as MP3, AAC, and MPEG files. In some implementations, the mobile device 100 can include the functionality of an MP3 player, such as an iPod™. The mobile device 100 may, therefore, include a 36-pin connector that is compatible with the iPod. Other input/output and control devices can also be used.

The memory interface 302 can be coupled to memory 350. The memory 350 can include high-speed random access memory and/or non-volatile memory, such as one or more magnetic disk storage devices, one or more optical storage devices, and/or flash memory (e.g., NAND, NOR). The memory 350 can store an operating system 352, such as Darwin, RTXC, LINUX, UNIX, OS X, WINDOWS, or an embedded operating system such as VxWorks. The operating system 352 may include instructions for handling basic system services and for performing hardware dependent tasks. In some implementations, the operating system 352 can be a kernel (e.g., UNIX kernel).

The memory 350 may also store communication instructions 354 to facilitate communicating with one or more additional devices, one or more computers and/or one or more servers. The memory 350 may include graphical user interface instructions 356 to facilitate graphic user interface processing; sensor processing instructions 358 to facilitate sensor-related processing and functions; phone instructions 360 to facilitate phone-related processes and functions; electronic messaging instructions 362 to facilitate electronic-messaging related processes and functions; web browsing instructions 364 to facilitate web browsing-related processes and functions; media processing instructions 366 to facilitate media processing-related processes and functions; GPS/Navigation instructions 368 to facilitate GPS and navigation-related processes and instructions; camera instructions 370 to facilitate camera-related processes and functions; and/or other software instructions 372 to facilitate other processes and functions, e.g., security processes and functions, and processes and functions related to the systems and techniques described in this specification (e.g., process 700). The memory 350 may also store other software instructions (not shown), such as web video instructions to facilitate web video-related processes and functions; and/or web shopping instructions to facilitate web shopping-related processes and functions. In some implementations, the media processing instructions 366 are divided into audio processing instructions and video processing instructions to facilitate audio processing-related processes and functions and video processing-related processes and functions, respectively. An activation record and International Mobile Equipment Identity (IMEI) 374 or similar hardware identifier can also be stored in memory 350.

Each of the above identified instructions and applications can correspond to a set of instructions for performing one or more functions described above. These instructions need not be implemented as separate software programs, procedures, or modules. The memory 350 can include additional instructions or fewer instructions. Furthermore, various functions of the mobile device 100 may be implemented in hardware and/or in software, including in one or more signal processing and/or application specific integrated circuits.

### Example Toolbar Implementations

Toolbar Overview

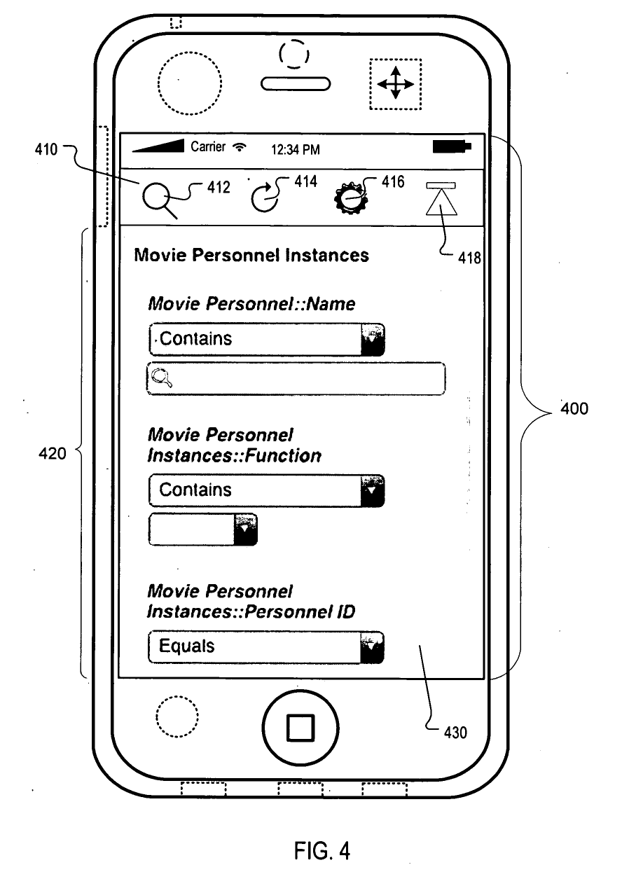

FIG. 4 illustrates an example interface 400 (e.g., a user interface) that includes a toolbar 410. In some implementations, the interface 400 can be a user interface for a mobile device (e.g., mobile device 100), for example. The interface 400 can include a browser 420. The browser 420 can be used to view and/or edit resources. For example, the browser 420 can be a web browser such as Safari™ that can display resources, such as but not limited to web pages, images, audio, video, and text.

Other implementations are possible. For example, the browser 420 can be a software application for viewing and/or editing other types of electronic documents. An electronic document (which for brevity will simply be referred to as a document) does not necessarily correspond to a file. A document may be stored in a portion of a file that holds other documents, in a single file dedicated to the document in question, or in multiple coordinated files.

The browser 420 can receive and display a web page 430. In some implementations, the web page 430 can be identified by the web browsing instructions 364, for example. The web page 430 can include objects (e.g., user interface elements) that allow a user to interact with the web page 430. For example, the web page 430 includes input fields that allow a user to search “Movie Personnel Instances” by specifying criteria such as a movie personnel's name, function, and/or personnel ID. The web page 430 may support interactions such as submitting search criteria, resetting input fields, changing settings, and navigating to certain portions of the web page 430 (e.g., directly to the top or bottom of the web page).

In some implementations, the web page 430 can include objects (e.g., controls) that are related to interactions supported by the web page 430. The controls can be disposed in different portions of the web page 430, such that the controls are not always visible in the interface 400. For example, a “submit” button may be included in a portion of the web page 430 that is not currently displayed in the interface. In some implementations, the web page 430 may not even include controls that are related to interactions supported by the web page 430. For example, the web page 430 may not include navigation controls for navigating to certain portions of the web page 430.

The toolbar 410 can be generated to include tools that correspond to the interactions. The toolbar 410 can be superimposed on the interface 400, such that the tools are available to the user regardless of the portion of the web page 430 or controls that are currently being displayed by the browser 420.

Generating Tools and the Toolbar

In some implementations, a resource can be automatically analyzed or parsed to determine interactions supported by the resource, or identify user interface elements in the resource. For example, HTML code of the web page 430 can be parsed to determine that the web page 430 supports interactions such as submission of search criteria, reset of the input fields, changes in the settings, and navigation directly to the top of the web page 430. A type of the browser 420 can also be determined to ensure that the interactions are also supported by the browser 420. Examples of types of browsers include Safari™, and Mozilla Firefox™. Tools corresponding to the determined interactions can be generated and used to generate a toolbar 410.

In some implementations, a resource can be manually analyzed or parsed (e.g., by a user) to determine interactions supported by the resource. A toolbar can be generated for interactions supported by the resource. For example, a user that generated the resource (e.g., a web page developer that coded the web page 430) can configure the resource, such that the resource includes information that specifies interactions supported by the resource. A type of the browser 420 can also be determined to ensure that the interactions are also supported by the browser 420. A toolbar with tools corresponding to the specified interactions can be generated (e.g., by the web page developer) based on the interactions supported by the resource and the browser 420.

After the toolbar 410 is generated, the toolbar 410 can be superimposed or overlaid on the interface 400, such that it is “floating” over the interface 400. As shown in FIG. 4, the toolbar 410 can be superimposed on the browser 420. Because the toolbar 410 is superimposed on the interface 400, the user can interact with the resource without navigating to particular portions of the resource that include objects that correspond to the interactions. For example, the browser 420 is not currently displaying objects corresponding to resetting the input fields, changing the settings, or navigating to the top of the web page 430. In addition, although the web page 430 includes input fields to specify search criteria, a “submit” button is also not visible in the portion of the web page 430 displayed in the interface 400.

The toolbar 410 includes tools 412, 414, 416, and 418 that can provide the interactions of submitting search criteria, resetting the input fields, changing settings, and navigating directly to the top, respectively. Other implementations are possible. For example, tools on the toolbar 410 can be generated to perform actions, such as but not limited to navigation within and between resources, opening/closing new interface elements, performing other actions, and automatically performing actions that a user may otherwise perform manually.

As another example, if the resource is a database of records, the toolbar 410 can include tools that correspond to interactions such as, navigating to a first record, navigating to a previous record, navigating to a next record, navigating a last record, changing the sorting options, and navigating to a top of a current record. Other implementations are possible. For example, the tools can be generated based on the orientation of the interface (e.g., portrait display, landscape display). In addition, the tools can be generated based on a type of gesture (e.g., double-tap, pinch, multi-touch, single-touch) and a direction of the gesture.

Toolbar Configurations

In some implementations, the toolbar 410 can be superimposed on a portion of the interface 400 that is not displaying the browser 420. Furthermore, a user could also adjust a configuration of the toolbar 410. For example, the user can adjust the size or position of the toolbar 410. The user can also rearrange positions of the tools on the toolbar. In addition, the user can adjust an opacity of the toolbar 410 (e.g., the toolbar can be translucent). In some implementations, the user can configure the toolbar 410 such that the toolbar 410 is normally hidden, and the toolbar is shown in response to a specified user input (e.g., a particular gesture, activating the browser, pressing a button).

In some implementations, the tools that are presented in the toolbar 410 can be determined and generated based on user input (e.g., gestures). For example, a user may perform a gesture analogous to pinching the user's fingers on a touch-sensitive display. The pinching may be associated with zooming in on a resource being displayed in the interface. Based on the gesture (e.g., the pinching), tools related to zooming (e.g., zooming in, zooming out, centering the display) can be generated and disposed in the toolbar 410. Other implementations are possible.

Because the toolbar 410 and its tools can be presented on the interface, regardless of the portion of the resource being displayed, a user can more easily perform interactions that correspond to the tools. The user does not have to navigate to a specific portion of the resource that includes an object that corresponds to an interaction. Furthermore, as described previously, some tools correspond to interactions that may not have corresponding objects in the resource. Because the toolbar can be displayed in a stationary position on the interface, the user can more easily perform the interaction, because a corresponding tool can be in a known location on the interface.

In some implementations, the position of the toolbar 410 in the interface can also be automatically adjusted based on user input. For example, the position of the toolbar 410 can be adjusted if the user changes the orientation of the interface from a portrait display to a landscape display, such that the toolbar is superimposed on the interface either horizontally or vertically across the interface. Other implementations are possible. For example, the user can pan across tools (e.g., tools not currently displayed) in the toolbar 410 by sliding the user's finger across the toolbar.

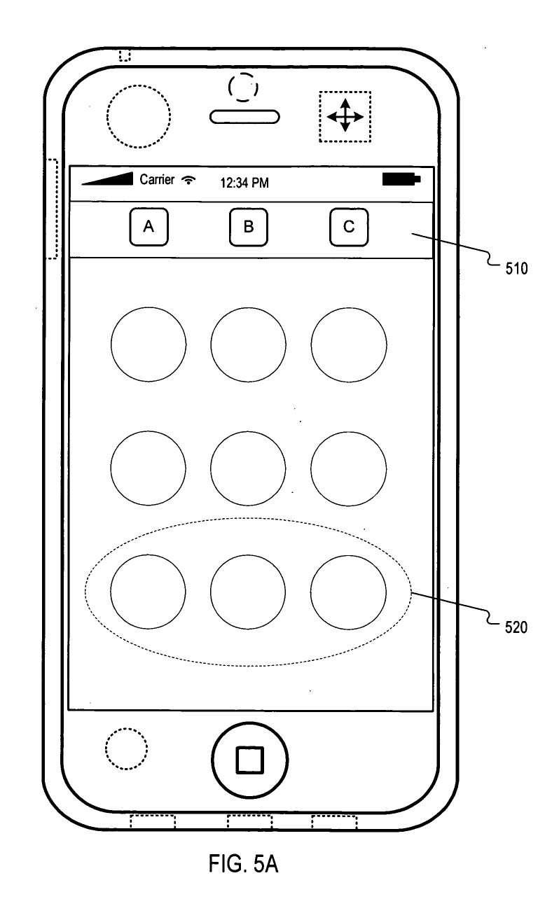

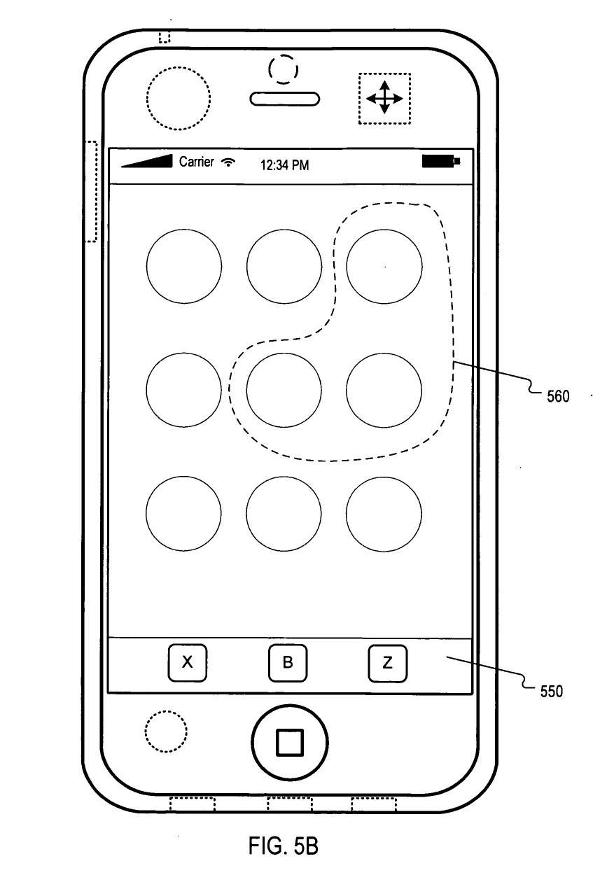

FIG. 5A illustrates an example interface that includes a toolbar 510 presented at a location based on a first user input 520. The toolbar includes tools “A”, “B”, and “C”. Based on the first user input 520 (e.g., a gesture represented by the dotted line), the toolbar 510 is positioned at the top of the interface. The toolbar 510 can be placed at the top of the interface, for example, so that the user's input is not impeded by the toolbar 510 (e.g., if the toolbar were placed adjacent to the location of the gesture).

FIG. 5B illustrates an example interface that includes a toolbar 550 presented at a location based on a second user input 560. Note that the toolbar 550 includes the tools “X”, “B”, and “Z”. Because the second user input 560 can be different from the first user input 520 (e.g., different objects are selected by user input 560), the tools generated for the toolbar 510 in FIG. 5B can be different from the tools generated for the toolbar 550 in FIG. 5A. In addition, as shown in FIG. 5B, based on the second user input 560, the toolbar 550 can be presented at a location (e.g., at the bottom of the interface) different from the location in FIG. 5A. Presenting the toolbar 550 at the top of the interface in this example would be more likely to impede the user's input.

Additional Tools

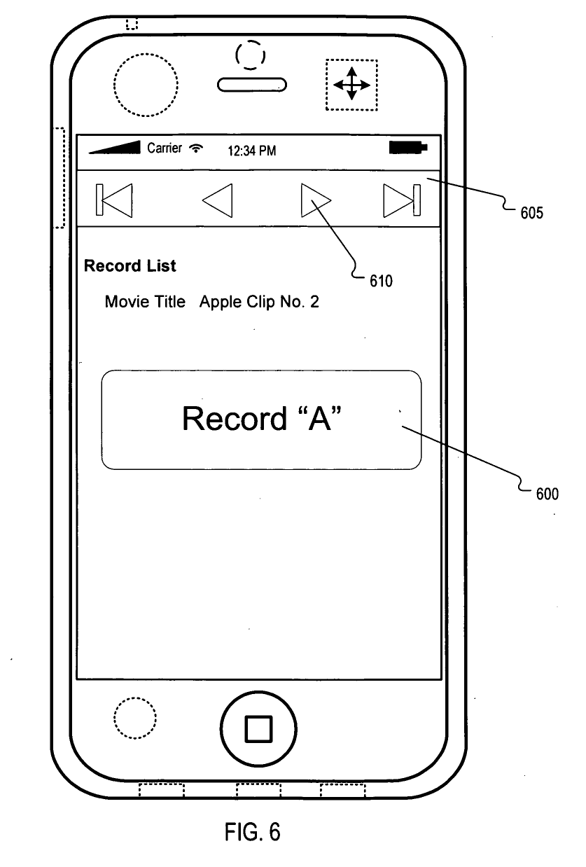

FIG. 6 illustrates an example interface that includes a heads up display 600. When a user invokes a tool in a toolbar 605, a heads up display 600 can be generated based on the user input used to invoke the tool, and the heads up display 600 can be presented on the interface. The heads up display can display information associated with the use of the tool. For example, a user can be navigating quickly through records of a database by continuously invoking a tool 610 that corresponds to navigating to a next record. In response to the continuous use of the tool 610, a heads up display 600 can be presented on the interface that shows a relative location in a database that the user has navigated to. For example, if the records are sorted in alphabetical order, the heads up display 600 can present the letter “A” when the user is navigating through records that begin with the letter “A”, and the heads up display can present the letter “B” when the user is navigating through records that begin with the letter “B”.

Other implementations of a heads up display are possible. Returning to the previous example, the heads up display can play a sound (e.g., through speaker 328) that represents the information (e.g., a phonetic “A”). In addition, other types of information can be displayed in the heads up display. For example, if a user is deleting or adding records to the database, the heads up display can present statistical information (e.g., memory usage, total records in the database). Furthermore, a heads up display can be generated and presented on the interface in response to a predetermined event. Examples of predetermined events include loading of a resource (e.g., a webpage), and closing of a resource. As a further example, a heads up display can be generated and presented on the interface after a predetermined time after a predetermined event (e.g., 5 seconds after a resource is loaded).

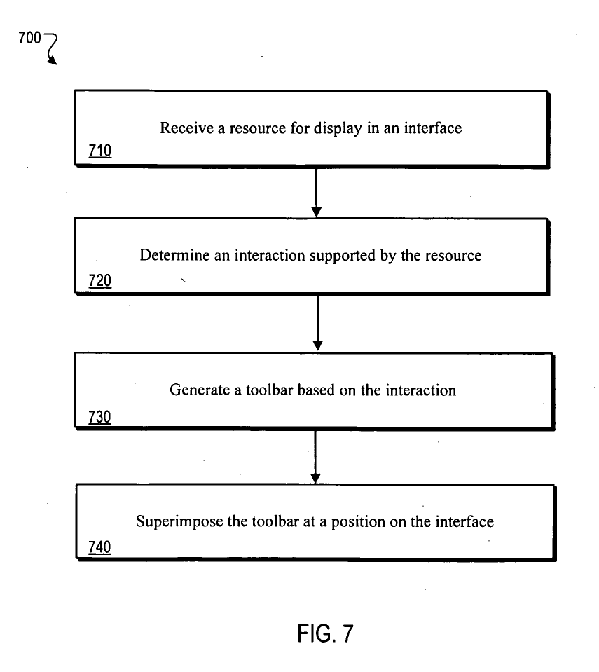

FIG. 7 is a flow diagram of an example process 700 for superimposing a toolbar on an interface. The process 700 can include receiving 710 a resource for display in an interface. For example, the mobile device 202a can receive a portal web page, for display in an interface of the mobile device 202a, from a media service 250 to access media files. The process 700 also includes determining 720 an interaction supported by the resource. For example, web browsing instructions 364 stored in memory 350 (e.g., of the mobile device 202a) can be used to analyze the web page and determine an interaction supported by the resource (e.g., an interaction corresponding to a user interface element in the web page). In addition, the process 700 can include generating 730 a toolbar based on the interaction. For example, toolbar instructions included in the other software instructions 372, and the GUI instructions 356, can be used to generate a toolbar. Furthermore, the process 700 can include superimposing 740 the toolbar at a position on the interface. For example, the GUI instructions 356 can be used to superimpose the toolbar at a position on the interface.

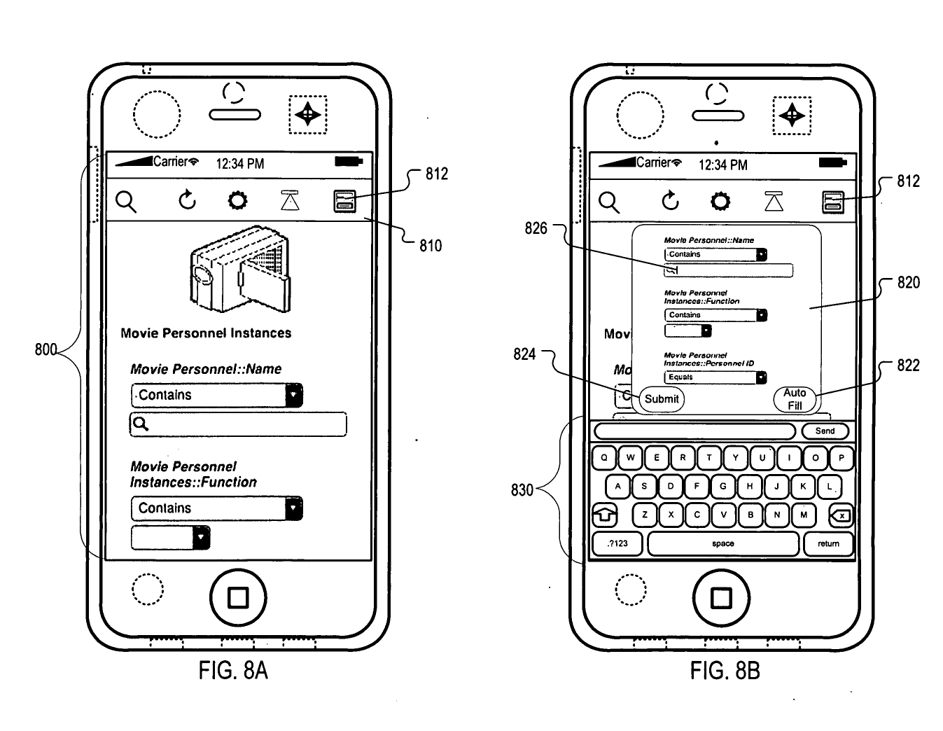

FIG. 8A illustrates an example interface 800 that includes a toolbar 810. The interface 800 is displaying a portion of the web page 430 of FIG. 4. Note that the portion of the web page 430 displayed does not include an object (e.g., a user interface element) for specifying personnel ID. As previously described, the web page 430 can be analyzed or parsed to determine interactions supported by the resource, or identify user interface elements in the resource. For example, a JavaScript interpreter (e.g., a JavaScript interpreter in WebKit) can be used to parse the web page 430 to determine potential user interface elements (e.g., input elements such as input fields, radio buttons, drop down lists) and generate an element tree. The input elements can be identified using heuristics, for example. After the input elements are identified, a tool 812 can be generated and presented in the toolbar 810.

FIG. 8B illustrates the example interface 800 of FIG. 8A that further includes a heads up display 820. When the tool 812 is invoked, a heads up display 820 can be generated and superimposed on the interface 800. In some implementations, the heads up display 820 can be a translucent window. Generating the heads up display 820 can include generating objects (e.g., input elements) that correspond to the input elements that were identified in the web page 430. For example, the heads up display 820 includes input elements related to specifying search criteria for a personnel's name and function. Note that the heads up display 820 also includes an input element that is related to specifying search criteria for a personnel's ID, which is not viewable in the portion of the web page 430 displayed in the interface 800 of FIG. 8A. By aggregating user interface elements in the web page 430 in the heads up display 820, the user experience can be improved. In particular, the user does not have to navigate through the entire resource to locate and interact with the user interface elements, which can be particularly difficult in mobile devices with decreased screen sizes.

In some implementations, an auto fill feature can also be provided in the heads up display 820 by an “Auto Fill” object 822. For example, techniques for generating auto fill forms can be used to generate the input elements in the heads up display 820. Invoking the “Auto Fill” object 822 allows a user to specify predetermined input in one or more of the input elements. In addition, a “Submit” object 824 can also be included in the heads up display 820. When the “Submit” object 824 is invoked (e.g. tapped on a touch-sensitive display), the information specified in the heads up display 820 can be transferred to corresponding input elements in the web page 430.

In some implementations, a virtual keyboard 830 can be displayed in the interface 800, e.g., concurrently with the heads up display 820. The virtual keyboard 830 can provide another input method for interacting with the heads up display 820. The virtual keyboard 830 can include a “return” key. The “return” key can be remapped to a function that corresponds to a “tab” key so that the user can navigate (e.g., move a cursor or selection) between the input elements displayed in the heads up display 820. In some implementations, a cursor 826, that indicates a location where input will be entered, can be automatically generated in an input field at the top of the heads up display 820, for example. Aggregating the input elements of the web page 430 can also be advantageous, because the concurrent presentation of the heads up display 820 and the virtual keyboard 830 decreases an amount of user interaction (e.g., navigating to locate the input elements in the web page 430, and invoking the virtual keyboard 830 for each input element). Other implementations are possible. For example, invoking the “Submit” object 824 can result in direct submission of data input in the heads up display 820, as if the user had directly submitted the data through the web page 430.

Other implementations and applications of the described systems and techniques are possible. For example, a toolbar can be generated and used for other types of resources, browsers, software applications, and interactions. The browser 420 can be an email application such as Mail for OS X that can display an inbox of emails. A toolbar can be generated with tools that correspond to interactions, such as but not limited to checking mail, deleting mail, sorting mail, composing mail, and other interactions supported by the email application. If a user invokes a tool corresponding to composing mail, the toolbar can be automatically modified so that it includes tools such as formatting tools (e.g., changing fonts, underlining), spellchecking tools, and tools for sending mail.

In addition, more than one toolbar can be generated and presented in the interface. The one or more toolbars (or corresponding tools) do not have to be “floating” or superimposed on the interface. Furthermore, in some implementations, a toolbar may not be generated. For example, a resource (e.g., a web page) can be identified, and one or more user interface elements in the resource can also be identified. A tool can be generated based on the user interface elements, and the tool (e.g., tool 414) can be combined with the resource for display in the interface.

The features described can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
receiving a resource for display in an interface;
determining an interaction supported by the resource;
generating a toolbar based on the interaction; and
superimposing the toolbar at a position on the interface.

2. The method of claim 1, wherein generating a toolbar includes:
generating a tool that corresponds to the interaction; and
presenting the tool in the toolbar.

3. The method of claim 2, wherein the interface is not currently displaying an object that corresponds to the tool.

4. The method of claim 1, wherein the position is based on an orientation of the interface.

5. The method of claim 1, further comprising:
receiving user input; and
adjusting the position of the toolbar based on the user input.

6. The method of claim 5, wherein the user input comprise gestures or interactions received on a touch-sensitive display.

7. The method of claim 1, further comprising:
receiving user input;
generating a second tool based on the user input; and
presenting the second tool in the toolbar.

8. The method of claim 1, further comprising:
receiving user input through the toolbar;
generating a heads up display based on the user input; and
presenting the heads up display on the interface.

9. The method of claim 1, wherein the resource is a web page.

10. A method comprising:
identifying a resource for display in an interface;
identifying one or more user interface elements in the resource;
generating a tool based on the one or more user interface elements; and
combining the tool and the resource for display in the interface.

11. The method of claim 10, further comprising:
receiving first user input through the tool;
generating a heads up display based on the one or more user interface elements, in response to the first user input; and
presenting the heads up display on the interface.

12. The method of claim 11, further comprising:
presenting a virtual keyboard on the interface.

13. The method of claim 11, further comprising:
receiving second user input through the heads up display; and
transferring the second user input to the resource.

14. A system comprising:
a processor; and
memory coupled to the processor and storing instructions which, when executed by the processor, cause the processor to perform operations comprising:
receiving a resource for display in an interface;
determining an interaction supported by the resource;
generating a toolbar based on the interaction; and
superimposing the toolbar at a position on the interface.

15. A computer-readable medium having instructions stored thereon, which, when executed by a processor, cause the processor to perform operations comprising:
receiving a resource for display in an interface;
determining an interaction supported by the resource;
generating a toolbar based on the interaction; and
superimposing the toolbar at a position on the interface.

16. A system comprising:
a processor; and
memory coupled to the processor and storing instructions which, when executed by the processor, cause the processor to perform operations comprising:
identifying a resource for display in an interface;
identifying one or more user interface elements in the resource;
generating a tool based on the one or more user interface elements; and
combining the tool and the resource for display in the interface.

17. A computer-readable medium having instructions stored thereon, which, when executed by a processor, cause the processor to perform operations comprising:
identifying a resource for display in an interface;
identifying one or more user interface elements in the resource;
generating a tool based on the one or more user interface elements; and
combining the tool and the resource for display in the interface.
